(19) United States
(12) Patent Application Publication
(10) Pub. No.: US 2026/0012274 A1
(43) Pub. Date: Jan. 8, 2026

(54) APPARATUS, METHODS AND COMPUTER PROGRAMS

(71) Applicant: Nokia Solutions and Networks Oy, Espoo (FI)

(72) Inventors: Yijia FENG, Shanghai (CN); Chen Hui YE, Shanghai (CN); Dani Johannes KORPI, Espoo (FI)

(21) Appl. No.: 19/118,056

(22) PCT Filed: Oct. 10, 2022
(86) PCT No.: PCT/CN2022/124458

§ 371 Date: Apr. 3, 2025

(51) Int. Cl. H04B 17/391; G06N 3/0455; G06N 3/084; H04B 17/309

(52) U.S. Cl. CPC H04B 17/3913; G06N 3/0455; G06N 3/084; H04B 17/309

(57) ABSTRACT

A method comprises determining a discrepancy based on information relating to a first set of codewords and information relating to a second set of codewords, the first set of codewords being received from a user equipment and providing information about a channel between the user equipment and a base station, the user equipment using a first model, trained with a first set of training data, to generate the first set of codewords.

### FIELD OF THE DISCLOSURE

The present disclosure relates to apparatus, methods, and computer programs for communication systems and in particular but not exclusively to apparatus, methods and computer programs relating codewords providing channel information.

### BACKGROUND

A communication system can be seen as a facility that enables communications between two or more communication devices, or provides communication devices access to a data network.

A communication system may be a wireless communication system. Examples of wireless communication systems comprise public land mobile networks (PLMN) operating based on radio access technology standards such as those provided by 3GPP (Third Generation Partnership Project) or ETSI (European Telecommunications Standards Institute), satellite communication systems and different wireless local networks, for example wireless local area networks (WLAN). Wireless communication systems operating based on a radio access technology can typically be divided into cells, and are therefore often referred to as cellular systems.

A communication system and associated devices typically operate in accordance with one or more radio access technologies defined in a given specification of a standard, such as the standards provided by 3GPP or ETSI, which sets out what the various entities associated with the communication system and the communication devices accessing or connecting to the communication system are permitted to do and how that should be achieved. Communication protocols and/or parameters which shall be used by communication devices for accessing or connecting to a communication system are also typically defined in standards. Examples of a standard are the so-called LTE (Long-term Evolution) and 5G (5^{th} Generation) standards provided by 3GPP.

### SUMMARY

According to an aspect, there is provided a method comprising: determining a discrepancy based on information relating to a first set of codewords and information relating to a second set of codewords, the first set of codewords being received from a user equipment and providing information about a channel between the user equipment and a base station, the user equipment using a first model, trained with a first set of training data, to generate the first set of codewords.

The second set of codewords may be obtained from a stored set of data.

The stored set of data may comprise the first set of training data.

The method may comprise triggering the determining of the discrepancy in response to a system level indicator crossing a threshold and using the discrepancy to update the first model.

The method may comprise, based on the discrepancy, determining if the first model is to be updated.

The determining if the first model is to be updated may comprise comparing the discrepancy to a threshold.

The updating of the first model may comprise updating a neural network of the first model.

The method may comprise updating the first model by training the neural network of the first model using a back propagation algorithm to determine one or more updated parameters for a layer of the neural network of the first model.

The method may comprise causing the one or more updated parameters to be sent to the user equipment to update the first model at the user equipment.

The one or more updated parameters may be gradients for the layer of the neural network of the first model.

The updating of the model may comprise retraining of the model with an updated set of training data.

The codewords may provide channel state information.

The codewords may provide channel information in a multiple input multiple output environment.

The method may comprise training the first model to provide encoding in the user equipment using the first set of training data and causing the first model to be provided to the user equipment.

The method may comprise training a second model to provide decoding in the base station, the training of the second model using the first set of training data.

The method may comprise training the second model to provide decoding in the base station using an output of the first model.

The method may comprise determining a reconstruction loss based on input to the first model and output from the second model and updating the first model in dependence on the discrepancy and the reconstruction loss.

The method may comprise determining the discrepancy based on a measure of a distance between a distribution of the first codewords and a distribution of the second codewords.

The method may comprise when it determined that the first model is to be updated, updating the second model.

The method may be performed by an apparatus. The apparatus may be provided in a base station or be a base station.

According to another aspect, there is provided an apparatus comprising: means for determining a discrepancy based on information relating to a first set of codewords and information relating to a second set of codewords, the first set of codewords being received from a user equipment and providing information about a channel between the user equipment and a base station, the user equipment using a first model, trained with a first set of training data, to generate the first set of codewords.

The second set of codewords may be obtained from a stored set of data.

The stored set of data may comprise the first set of training data.

The apparatus may comprise means for triggering the determining of the discrepancy in response to a system level indicator crossing a threshold and using the discrepancy to update the first model.

The apparatus may comprise means for, based on the discrepancy, determining if the first model is to be updated.

The determining if the first model is to be updated may comprise comparing the discrepancy to a threshold.

The updating of the first model may comprise updating a neural network of the first model.

The apparatus may comprise means for updating the first model by training the neural network of the first model using a back propagation algorithm to determine one or more updated parameters for a layer of the neural network of the first model.

The apparatus may comprise means for causing the one or more updated parameters to be sent to the user equipment to update the first model at the user equipment.

The one or more updated parameters may be gradients for the layer of the neural network of the first model.

The updating of the model may comprise retraining of the model with an updated set of training data.

The codewords may provide channel state information.

The codewords may provide channel information in a multiple input multiple output environment.

The apparatus may comprise means for training the first model to provide encoding in the user equipment using the first set of training data and causing the first model to be provided to the user equipment.

The apparatus may comprise means for training a second model to provide decoding in the base station, the training of the second model using the first set of training data.

The apparatus may comprise means for training the second model to provide decoding in the base station using an output of the first model.

The apparatus may comprise means for determining a reconstruction loss based on input to the first model and output from the second model and updating the first model in dependence on the discrepancy and the reconstruction loss.

The apparatus may comprise means for determining the discrepancy based on a measure of a distance between a distribution of the first codewords and a distribution of the second codewords.

The apparatus may comprise means for, when it determined that the first model is to be updated, updating the second model.

The apparatus may be provided in a base station or be a base station.

According to another aspect, there is provided an apparatus comprising circuitry configured to: determine a discrepancy based on information relating to a first set of codewords and information relating to a second set of codewords, the first set of codewords being received from a user equipment and providing information about a channel between the user equipment and a base station, the user equipment using a first model, trained with a first set of training data, to generate the first set of codewords.

The second set of codewords may be obtained from a stored set of data.

The stored set of data may comprise the first set of training data.

The circuitry may be configured to trigger the determining of the discrepancy in response to a system level indicator crossing a threshold and using the discrepancy to update the first model.

The circuitry may be configured to, based on the discrepancy, determine if the first model is to be updated.

The determining if the first model is to be updated may comprise comparing the discrepancy to a threshold.

The updating of the first model may comprise updating a neural network of the first model.

The circuitry may be configured to update the first model by training the neural network of the first model using a back propagation algorithm to determine one or more updated parameters for a layer of the neural network of the first model.

The circuitry may be configured to causing the one or more updated parameters to be sent to the user equipment to update the first model at the user equipment.

The one or more updated parameters may be gradients for the layer of the neural network of the first model.

The updating of the model may comprise retraining of the model with an updated set of training data.

The codewords may provide channel state information.

The codewords may provide channel information in a multiple input multiple output environment.

The circuitry may be configured to train the first model to provide encoding in the user equipment using the first set of training data and cause the first model to be provided to the user equipment.

The circuitry may be configured to train a second model to provide decoding in the base station, the training of the second model using the first set of training data.

The circuitry may be configured to train the second model to provide decoding in the base station using an output of the first model.

The circuitry may be configured to determine a reconstruction loss based on input to the first model and output from the second model and update the first model in dependence on the discrepancy and the reconstruction loss.

The circuitry may be configured to determine the discrepancy based on a measure of a distance between a distribution of the first codewords and a distribution of the second codewords.

The circuitry may be configured, when it determined that the first model is to be updated, to update the second model.

The apparatus may be provided in a base station or be a base station.

According to another aspect, there is provided an apparatus comprising at least one processor and at least one memory storing instructions that, when executed by the at least one processor cause the apparatus at least to: determine a discrepancy based on information relating to a first set of codewords and information relating to a second set of codewords, the first set of codewords being received from a user equipment and providing information about a channel between the user equipment and a base station, the user equipment using a first model, trained with a first set of training data, to generate the first set of codewords.

The second set of codewords may be obtained from a stored set of data.

The stored set of data may comprise the first set of training data.

The apparatus may be caused to trigger the determining of the discrepancy in response to a system level indicator crossing a threshold and using the discrepancy to update the first model.

The apparatus may be caused to, based on the discrepancy, determine if the first model is to be updated.

The determining if the first model is to be updated may comprise comparing the discrepancy to a threshold.

The updating of the first model may comprise updating a neural network of the first model.

The apparatus may be caused to update the first model by training the neural network of the first model using a back propagation algorithm to determine one or more updated parameters for a layer of the neural network of the first model.

The apparatus may be caused to causing the one or more updated parameters to be sent to the user equipment to update the first model at the user equipment.

The one or more updated parameters may be gradients for the layer of the neural network of the first model.

The updating of the model may comprise retraining of the model with an updated set of training data.

The codewords may provide channel state information.

The codewords may provide channel information in a multiple input multiple output environment.

The apparatus may be caused to train the first model to provide encoding in the user equipment using the first set of training data and cause the first model to be provided to the user equipment.

The apparatus may be caused to train a second model to provide decoding in the base station, the training of the second model using the first set of training data.

The apparatus may be caused to train the second model to provide decoding in the base station using an output of the first model.

The apparatus may be caused to determine a reconstruction loss based on input to the first model and output from the second model and update the first model in dependence on the discrepancy and the reconstruction loss.

The apparatus may be caused to determine the discrepancy based on a measure of a distance between a distribution of the first codewords and a distribution of the second codewords.

The apparatus may be caused, when it determined that the first model is to be updated, to update the second model.

The apparatus may be provided in a base station or be a base station.

According to another aspect, there is provided a method comprising: using a first model to generate first codewords, the first codewords providing information about a channel between a user equipment and a base station; and receiving from the base station, an update to the first model, wherein the update comprises one or more updated parameters for a layer of a neural network of the first model.

The first model may receive a set of channel information which is encoded by the first model to generate a respective first codeword.

The one or more updated parameters may comprise gradients for the layer of the neural network of the first model.

The codewords may provide channel state information.

The codewords may provide channel information in a multiple input multiple output environment.

The method may be performed by an apparatus. The apparatus may be provided in a user equipment or be a user equipment.

According to another aspect, there is provided an apparatus comprising: means for using a first model to generate first codewords, the first codewords providing information about a channel between a user equipment and a base station; and means for receiving from the base station, an update to the first model, wherein the update comprises one or more updated parameters for a layer of a neural network of the first model.

The first model may receive a set of channel information which is encoded by the first model to generate a respective first codeword.

The one or more updated parameters may comprise gradients for the layer of the neural network of the first model.

The codewords may provide channel state information.

The codewords may provide channel information in a multiple input multiple output environment.

The apparatus may be provided in a user equipment or be a user equipment.

According to another aspect, there is provided an apparatus comprising circuitry configured to: use a first model to generate first codewords, the first codewords providing information about a channel between a user equipment and a base station; and receive from the base station, an update to the first model, wherein the update comprises one or more updated parameters for a layer of a neural network of the first model.

The first model may receive a set of channel information which is encoded by the first model to generate a respective first codeword.

The one or more updated parameters may comprise gradients for the layer of the neural network of the first model.

The codewords may provide channel state information.

The codewords may provide channel information in a multiple input multiple output environment.

The apparatus may be provided in a user equipment or be a user equipment.

According to another aspect, there is provided an apparatus comprising at least one processor and at least one memory storing instructions that, when executed by the at least one processor cause the apparatus at least to: use a first model to generate first codewords, the first codewords providing information about a channel between a user equipment and a base station; and receive from the base station, an update to the first model, wherein the update comprises one or more updated parameters for a layer of a neural network of the first model.

The first model may receive a set of channel information which is encoded by the first model to generate a respective first codeword.

The one or more updated parameters may comprise gradients for the layer of the neural network of the first model.

The codewords may provide channel state information.

The codewords may provide channel information in a multiple input multiple output environment.

The apparatus may be provided in a user equipment or be a user equipment.

According to another aspect, there is provided a method comprising: using a first model to generate first codewords, the first codewords providing information about a channel between a user equipment and a base station; and receiving from the base station, an update to the first model.

The first model may receive a set of channel information which is encoded by the first model to generate the respective first codeword.

The update may comprise an update to a neural network of the first and the second model.

The update may comprise one or more updated parameters for the layers of the neural network of the first and the second model.

To update the first model in the user equipment, the one or more updated parameters gradients for the layer of the neural network of the first model may be sent from base station to user equipment.

The codewords may provide channel state information.

The codewords may provide channel information in a multiple input multiple output environment.

The method may be performed by an apparatus. The apparatus may be provided in a user equipment or be a user equipment.

According to another aspect, there is provided an apparatus comprising: means for using a first model to generate first codewords, the first codewords providing information about a channel between a user equipment and a base station; and means for receiving from the base station, an update to the first model.

The first model may receive a set of channel information which is encoded by the first model to generate a respective first codeword.

The update may comprise an update to a neural network of the first model.

The update may comprise one or more updated parameters for the layers of the neural network of the first model.

The one or more updated parameters may comprise gradients for the layer of the neural network of the first model.

The codewords may provide channel state information.

The codewords may provide channel information in a multiple input multiple output environment.

The apparatus may be provided in a user equipment or be a user equipment.

According to another aspect, there is provided an apparatus comprising circuitry configured to: use a first model to generate first codewords, the first codewords providing information about a channel between a user equipment and a base station; and receive from the base station, an update to the first model.

The first model may receive a set of channel information which is encoded by the first model to generate a respective first codeword.

The update may comprise an update to a neural network of the first model.

The update may comprise one or more updated parameters for the layers of the neural network of the first model.

The one or more updated parameters may comprise gradients for the layer of the neural network of the first model.

The codewords may provide channel state information.

The codewords may provide channel information in a multiple input multiple output environment.

The apparatus may be provided in a user equipment or be a user equipment.

According to another aspect, there is provided an apparatus comprising at least one processor and at least one memory storing instructions that, when executed by the at least one processor cause the apparatus at least to: use a first model to generate first codewords, the first codewords providing information about a channel between a user equipment and a base station; and receive from the base station, an update to the first model.

The first model may receive a set of channel information which is encoded by the first model to generate a respective first codeword.

The update may comprise an update to a neural network of the first model.

The update may comprise one or more updated parameters for the layers of the neural network of the first model.

The one or more updated parameters may comprise gradients for the layer of the neural network of the first model.

The codewords may provide channel state information.

The codewords may provide channel information in a multiple input multiple output environment.

The apparatus may be provided in a user equipment or be a user equipment.

According to a further aspect, there is provided a computer program comprising instructions, which when executed by an apparatus, cause the apparatus to perform any of the methods set out previously.

According to a further aspect, there is provided a computer program comprising instructions, which when executed cause any of the methods set out previously to be performed.

According to an aspect there is provided a computer program comprising computer executable code which when executed cause any of the methods set out previously to be performed.

According to an aspect, there is provided a computer readable medium comprising program instructions stored thereon for performing at least one of the above methods.

According to an aspect, there is provided a non-transitory computer readable medium comprising program instructions which when executed by an apparatus, cause the apparatus to perform any of the methods set out previously.

According to an aspect, there is provided a non-transitory computer readable medium comprising program instructions which when executed cause any of the methods set out previously to be performed.

According to an aspect, there is provided a non-volatile tangible memory medium comprising program instructions stored thereon for performing at least one of the above methods.

In the above, many different aspects have been described. It should be appreciated that further aspects may be provided by the combination of any two or more of the aspects described above.

Various other aspects are also described in the following detailed description and in the attached claims.

### BRIEF DESCRIPTION OF THE FIGURES

Some example embodiments will now be described, by way of example only, with reference to the accompanying Figures in which:

FIG. 1 shows a schematic representation of a 5G system;

FIG. 2 shows a schematic representation of an apparatus;

FIG. 3 shows a schematic representation of a user equipment;

FIG. 4 shows a schematic representation of an auto encoder architecture;

FIG. 5a shows the distribution of a k-th feature learned from a dataset during training set;

FIG. 5b shows the distribution of the k-th feature in the data in a deployment environment;

FIG. 6 shows a schematic representation of an auto encoder architecture of some embodiments;

FIG. 7 shows a method of some embodiments;

FIG. 8 schematically shows an encoder and decoder of some embodiments;

FIGS. 9a and 9b show some simulation results;

FIG. 10 show another method of some embodiments;

FIG. 11 show another method of some embodiments; and

FIG. 12 shows a schematic representation of a non-volatile memory medium storing instructions which when executed by a processor allow a processor to perform one or more of the steps of any of the methods of FIGS. 7, 10 and 11.

### DETAILED DESCRIPTION

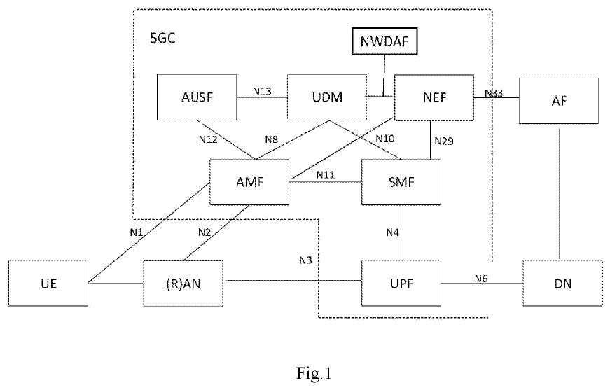

In the following certain embodiments are explained with reference to communication devices capable of communication via a wireless cellular system and mobile communication systems serving such communication devices. Before explaining in detail the exemplifying embodiments, certain general principles of a wireless communication system, access systems thereof, and communication devices are briefly explained with reference to FIGS. 1, 2 and 3 to assist in understanding the technology underlying the described examples.

FIG. 1 shows a schematic representation of a communication system operating based on a 5^{th} generation radio access technology (generally referred to as a 5G system (5GS)). The 5GS may a (radio) access network ((R)AN), a 5G core network (5GC), one or more application functions (AF) and one or more data networks (DN). A user equipment may access or connect to the one or more DNs via the 5GS.

The 5G (R)AN may comprise one or more base stations or radio access network (RAN) nodes, such as a gNodeB (gNB). A base station (BS) or RAN node may comprise one or more distributed units connected to a central unit.

The 5GC may comprise various network functions, such as an access and mobility management function (AMF), a session management function (SMF), an authentication server function (AUSF), a user data management (UDM), a user plane function (UPF) a network data analytics function (NWDAF) and/or a network exposure function (NEF). The operations performed by each of the various network functions of the 5G are described by way of example only in 3GPP TS 23.501 and TS 23.502 version 16.

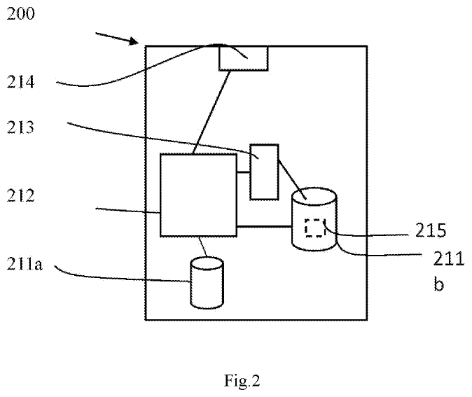

FIG. 2 illustrates an example of an apparatus 200. The apparatus 200 may be provided a radio access node such as a base station. The apparatus 200 may have at least one processor and at least one memory storing instructions that when executed by the at least one processor cause one or more functions to be performed. In this example, the apparatus may comprise at least one random access memory (RAM) 211a, and/or at least one read only memory (ROM) 211b, and/or at least one processor 212, 213 and/or an input/output interface 214. The at least one processor 212, 213 may be coupled to the RAM 211a and the ROM 211b. The at least one processor 212, 213 may be configured to execute an appropriate software code 215. The software code 215 may for example allow to perform one or more steps to perform one or more of the present aspects.

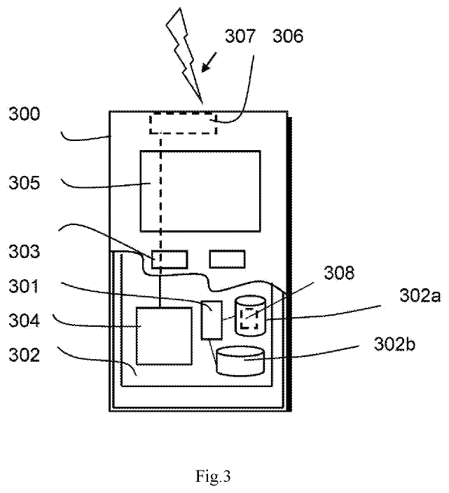

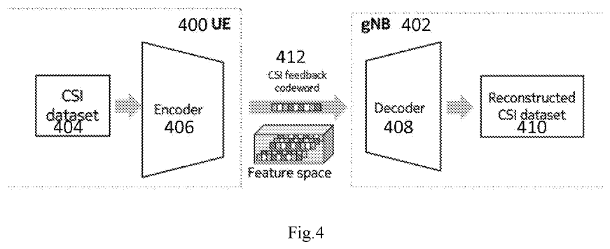

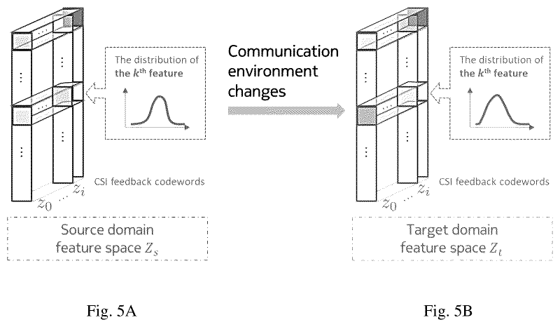

FIG. 3 illustrates an example of a communications device 300. The communications device 300 may be any device capable of sending and receiving radio signals. Non-limiting examples of a communication device 300 comprise a user equipment, such as the user equipment shown illustrated in FIG. 1, a mobile station (MS) or mobile device such as a mobile phone or what is known as a ‘smart phone’, a computer provided with a wireless interface card or other wireless interface facility (e.g., USB dongle), a personal data assistant (PDA) or a tablet provided with wireless communication capabilities, a machine-type communications (MTC) device, a Cellular Internet of things (CIoT) device or any combinations of these or the like. The communications device 300 may send or receive, for example, radio signals carrying communications. The communications may be one or more of voice, electronic mail (email), text message, multimedia, data, machine data and so on.

The communications device 300 may receive radio signals over an air or radio interface 307 via appropriate apparatus for receiving and may transmit radio signals via appropriate apparatus for transmitting radio signals. In FIG. 3 transceiver apparatus is designated schematically by block 306. The transceiver apparatus 306 may be provided for example by means of a radio part and associated antenna arrangement. The antenna arrangement may be arranged internally or externally to the mobile device and may include a single antenna or multiple antennas. The antenna arrangement may be an antenna array comprising a plurality of antenna elements.

The communications device 300 may be provided with at least one processor 301, and/or at least one ROM 302a, and/or at least one RAM 302b and/or other possible components 303 for use in software and hardware aided execution of tasks it is designed to perform, including control of access to and communications with access systems, such as the 5G RAN and other communication devices. The at least one processor 301 is coupled to the RAM 302b and the ROM 302a. The at least one processor 301 may be configured to execute instructions of software code 308. Execution of the instructions of the software code 308 may for example allow to the communication device 300 perform one or more operations. The software code 308 may be stored in the ROM 302a. It should be appreciated that in other embodiments, any other suitable memory may be alternatively or additionally used with the ROM and/or RAM examples set out above.

The at least one processor 301, the at least one ROM 302a, and/or the at least one RAM 302b can be provided on an appropriate circuit board, in an integrated circuit, and/or in chipsets. This feature is denoted by reference 304.

The communications device 300 may optionally have a user interface such as keypad 305, touch sensitive screen or pad, combinations thereof or the like. Optionally, the communication device may have one or more of a display, a speaker and a microphone.

In the following examples, the term UE or user equipment is used. This term encompasses any of the example of communication device 300 previously discussed and/or any other communication device.

An example of wireless communication systems are architectures standardized by the 3rd Generation Partnership Project (3GPP). The currently radio access technology being standardized by 3GPP is often referred to as 5G or NR. Other radio access technologies standardized by 3GPP include long term evolution (LTE) or LTE Advanced Pro of the Universal Mobile Telecommunications System (UMTS). Wireless communication systems generally include access networks, such as radio access networks operating based on a radio access technology that include base stations or a radio access network nodes. Wireless communication systems may also include other types of access networks, such as a wireless local area network (WLAN) and/or a WiMAX (Worldwide Interoperability for Microwave Access) network. It should be understood that example embodiments may also be used with standards for future radio access technologies such as 6G and beyond.

Downlink channel state information (CSI) is used by base stations (BS) to obtain channel response and precoding for beamforming in a downlink of a massive multiple-input multiple-output (MIMO) system. In MIMO systems, downlink CSI is first estimated by user equipment (UE) using pilot signals, then sent back to the BS as a feedback. However, due to the large number of antennas in a massive MIMO system, CSI feedback (based on for example, codebook-based methods and compressive sensing methods) may be bandwidth consuming. In such a MIMO system this approach may be relatively complex.

An AI/ML (artificial intelligence/machine learning) based CSI feedback enhancement approach is shown in FIG. 4. As shown in FIG. 4, an autoencoder architecture is provided. A set of CSI values are determined at the UE 400 for MIMO system to provide a CSI dataset 404. The original CSI dataset 404 is compressed by an encoder 406 at the UE 400 into a codeword 412, which is then sent to the BS/gNB 402. Upon receiving the CSI feedback codeword, a decoder at the BS/gNB 402 can reconstruct the CSI to provide a re-constructed CSI dataset 410. The CSI feedback codeword 412 condenses the most representative information of the input CSI data. These compressed CSI feedback codewords make up space called feature space, where the statistical characteristics of the codewords can be represented by the distribution of each feature/dimension.

Enhancing CSI feedback may improve performance. For example, there may be an overhead reduction, a CSI recovery accuracy improvement (leading to better performance), and/or prediction augmentation.

This may be in a context of different gNB-UE collaboration levels which may need to be supported.

The encoder in the UE and the decoder in the gNB/BS may use an AI/ML model. The adaptability of the AI/ML model should be considered in designing an AI/ML enabled CSI feedback solution. In this regard, reference is made to FIG. 5a and FIG. 5b. FIG. 5a shows the distribution of a k-th feature learned from a dataset during training set. FIG. 5b shows the distribution of the k-th feature in the data in a deployment environment. As can be seen from a comparison of FIGS. 5a and 5b, there may be a distribution drift in the feature space due to the environmental drift.

One option may be to retrain the model to fit the current environment. As shown in FIG. 4, the encoder and decoder are deployed in the UE and gNB/BS, respectively and would be (re)trained jointly in the gNB/UE before deployment. This may require a large volume of uncompressed original downlink CSI data need to be transmitted from UE back to gNB. This may require a relatively large resource expenditure in over-the-air data traffic and also of data storage.

Some embodiments may address issues relating to overfitting to a pre-trained model. As discussed in relation to FIGS. 5a and 5b, changes in the RF (radio frequency) propagation environment may lead to drifts in the CSI distributions. The pre-trained model for CSI feedback compression with the previous channel distributions may not fit to the new environment. This is known as the overfitting problem.

Some embodiments may address issues relating to traffic intensiveness in transmitting the original uncompressed CSI for model retraining. In order to retrain a model to fit an updated propagation environment, UE to gNB data transmission of original uncompressed CSI data may be traffic intensive. Furthermore, incessant monitoring of the channel state change may make traffic intensiveness a constant issue in CSI feedback transmission.

Some embodiments may transfer the CSI feedback compression model to a new environment in an unsupervised learning manner without any labelled CSI in-field data being required (i.e. retraining of the model with original uncompressed CSI data).

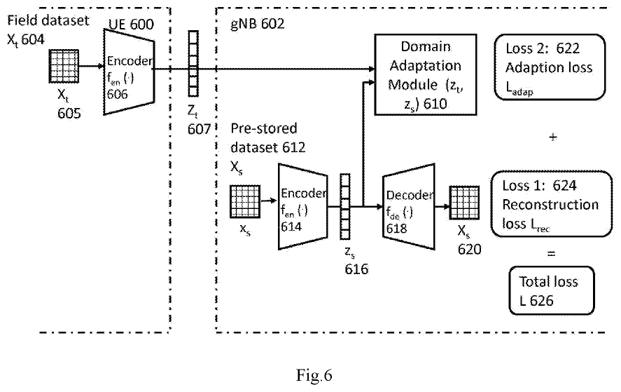

Reference is made to FIG. 6 which schematically shows an embodiment.

The UE 600 has an encoder 606. The encoder has a trained neural network or AI/ML model. This trained neural network or AI/ML model is downloaded from the gNB/BS 602. The field CSI data xₜ 605 from the deployment field environment is compressed as a vector z 607 by the encoder 606 on the UE and sent to the gNB.

The gNB/BS 602 trains encoder/decoder NN or AI/ML model. The gNB/BS uses data xₛ of a prestored data set 612 Xₛ as an input to train the NN or AI model. The NN or ML/AI model has an encoder part 614 and a decoder part 618. The output of the decoder part 618 is the reconstructed data set 620 Xₛ. Data xₛ of the prestored data set 612 Xₛ is provided as an input to the encoder part of the NN or AI/ML model. The encoder part of the of the NN or AI/ML model provides a codeword output zₛ which is input to the decoder part of the model. The encoder part 614 and a decoder part 618 are trained such that the data output by the decoder matches the input to the encoder. The trained encoder part of the NN or ML/AI model is downloaded by the UE.

It should be appreciated that the NN or ML/AI model for the encoder/decoder may be implemented using any suitable deep network architectures, for example fully connected (FC) layers, convolutional layers, long short-term memory (LSTM) networks, and/or the like.

In some embodiments, a ‘feature discrepancy’ metric is calculated or determined to assess the similarity of the compressed feature vectors of zₛ and zₜ (received from the UE). The feature discrepancy indicates the significance of environmental drift between training and deployment. In some embodiments, the feature discrepancy is implemented by a domain adaptation module Adp(zₜ, zₛ) functional block 610. The domain adaptation module may monitor the feature discrepancy.

The domain adaptation module may use any suitable technique.

For example, the domain adaptation module may use a deep adaptation approach such as a discrepancy-based formula. The discrepancy-based formula may be MMD (Maximum Mean Discrepancy). In some embodiments, this approach is not implemented by a NN (neural network)-based approach.

In another example, the domain adaptation module may use a domain adversarial approach. The domain adversarial approach may use a NN-based domain classifier.

In another example, the domain adaptation module may use a discrepancy-based n approach. In this example, the module may be implemented by at least one processor and at least one memory.

The domain adaptation module may be used for model-monitoring and/or model-finetuning. In the domain adaptation module, the difference between the pre-stored environment and drifted environment may be determined by the discrepancy between the compressed vector zₛ from the pre-stored environment and the compressed vector zₜ from drifted environment. The input to the domain adaptation module are the pre-stored CSI codeword datasets and the field codeword datasets.

With the determined discrepancy, the environment drift can be detected in the model-monitoring mode. By minimizing the discrepancy, the model may be finetuned to make the environment drift indistinguishable in the model-finetuning mode.

There discrepancy may be determined in any suitable manner.

In some embodiments, a deep adaptation approach may be used to determine the discrepancy. The deep adaptation approach may be based on a discrepancy between the pre-stored environment distribution and the field environment distribution. The distributions of different environments are determined from the codeword datasets of different environments.

In some embodiments, a measure of a distance between the distributions is used to determine discrepancy.

Some examples of measurement distances include Kullback-Leibler divergence (KL divergence), Jensen-Shannon divergence (JS divergence), Maximum Mean Discrepancy (MMD), and/or Wasserstein Distance, etc.

The Wasserstein distance or Kantorovich-Rubinstein metric is a distance function defined between probability distributions on a given metric space. In this case the distributions on the prestored environment distribution and the field environment distribution.

The Kullback-Leibler divergence (KL divergence) is a measure of the distance between two probability distributions. It is sometime referred to a relative entropy. In this case the distributions on the prestored environment distribution and the field environment distribution.

The Jensen-Shannon divergence is a method of measuring the similarity between two probability distributions. In this case the distributions on the prestored environment distribution and the field environment distribution.

If the distance is beyond a certain threshold, it can be considered that there is a great environment drift, and the pre-learned model does not fit the current propagation environment.

Maximum mean discrepancy (MMD) is a statistical test used to determine whether given two distribution are the same.

In the following example, MMD is used as an example in a deep adaptation approach.

MMD is defined to measure the discrepancy between two distributions. In practice, the empirical estimate of the MMD is used by calculating empirical expectations computed on the samples X and Y as

$$MMD [ F , X , Y ] := {sup}_{f ∈ F} ( \frac{1}{m} {\sum }_{i = 1}^{m} f ( {x}_{i} ) - \frac{1}{n} {\sum }_{i = 1}^{n} f ( {y}_{i} ) )$$

where F is a class of functions f:X→R.

When implementing. MMD can be determined using the kernel embedding technique as

$$MMD ( p , q ) = {E}_{{xx}^{′}} k ( x , {x}^{′} ) + {E}_{{yy}^{′}} k ( y , {y}^{′} ) - 2 {E}_{xy} k ( x , y ) ,$$

where k(⋅,⋅) can be any universal kernel, such as Gaussian

$$( x , {x}^{′} ) = {exp}^{\frac{{‖ x - {x}^{′} ‖}^{2}}{2 {σ}^{2}}} ,$$

x, x′˜p and y, y′˜q

In some embodiments, a domain adversarial approach may be used to determine the discrepancy. The domain adversarial approach is based on the domain classifier to discriminate whether the data are from the pre-learned environment or the field environment. If the result is indiscriminate, it means there is little difference between the pre-stored environment and the field environment. If the result is discriminable, it means there is a difference between the pre-stored environment and the field environment. A gradient reversal layer is added to the classifier, which intends to promote the features indiscriminate with respect to the environment drift.

Thus, if the feature discrepancy is smaller than a threshold, this indicates the deployment environment has a relatively high similarity to the training dataset and that the current model is suitable. If the discrepancy is larger than the threshold, retraining may be activated.

Alternatively or additionally, environmental drift can be determined based on one or more system-level indicators. The system-level indicator may comprise one or more of: key performance indicator (KPI); suitable parameter; and/or suitable metric. A KPI may for example be downlink throughput. If the indicator falls below a threshold (or rises above a threshold), retraining may be activated.

In some embodiments, the downlink throughput is adopted as a system-level metric to indicate whether there is a significant environment drift. Once the downlink throughput is below the threshold, the adaptation loss (Loss 2) calculated in the domain adaptation module through either deep adaptation or domain adversarial approach in FIG. 6 is activated for model retraining.

If retraining is required, a loss of feature discrepancy determined by the domain adaptation module, L_{adp}, is summed up with reconstruction loss L_{rec} in pre-stored training dataset to form a total loss L. Three ML blocks (i.e., domain adaptation module, encoder and decoder) may update their NN parameters with respect to the gradient of L. It should be noted that in the case where the retraining is initiated based on a system-level KPI, the loss function itself may still be calculated based on feature discrepancy L_{adp}, (and not the system-level KPI).

The reconstruction loss L_{rec} may be determined in any suitable way. The reconstruction loss L_{rec} may be regarded as a measurement of how similar (or different) the input CSI data to the model and the output reconstructed CSI data provided by the model.

For example, he reconstruction loss L_{rec} may be set to be the cosine similarity between the input CSI data and the output reconstructed CSI data, which can be expressed as

$${L}_{rec} = - E \{ \frac{1}{N} {\sum }_{i = 1}^{N} \frac{‖ {\tilde{w}}_{i}^{H} {w}_{i} ‖}{‖ {\tilde{w}}_{i} ‖ ‖ {w}_{i} ‖} \} ,$$

where wᵢ is the input original CSI vector of frequency unit i, \tilde{w}ᵢ is the output CSI vector of frequency unit i, N is the total number of frequency units, and E {⋅} denotes the average operation over multiple samples.

The adaptation losses may be presented depending on the approach used by the domain adaptation module.

For example, for a deep adaptation approach, the adaptation loss may be defined to be the distance between the pre-stored environment distribution and field environment distribution in domain adaptation module,

$${L}_{adp} = distance ( t , s )$$

where distance (⋅,⋅) can be any of the distances mentioned previously. For example, if the MMD is used as the distance to measure the discrepancy between the compressed feature spaces t and s, the above formula can be rewritten as

$$distance ( t , s ) = MMD ( t , s ) .$$

For example, for a domain adversarial approach, the adaption loss may be defined as

$${L}_{adp} = \frac{1}{2} ( {L}_{BCE} ( {z}_{s} , 1 ) + {L}_{BCE} ( {z}_{t} , 0 ) )$$

where L_{BCE}(⋅, label) is a binary cross entropy (BCE) loss, 1 and 0 are labels representing different environments.

The total loss may be the sum of the reconstruction loss and the adaptation loss, given as

$$L = {L}_{rec} + {L}_{adp}$$

By minimizing the total loss, the NN are trained using stochastic gradient descent with back-propagation. It should be noted that in order to update the encoder in UE, according to the theory of back-propagation algorithm, the gNB only needs to send the gradients of the last layer in encoder to UE. The size for the gradients of the last layer in the encoder may be small in this case (for example, the size of each input CSI sample denoted as N, the compression ratio as γ, the size for the nodes of the decoder's first layer will be γ·N).

Without requiring in-field original uncompressed CSI data, the ML based CSI compression and recovery model of some embodiments may augments its recovery accuracy in the deployment environment. In some embodiments, ‘overfitting’ to the training dataset may be avoided.

The approach of some embodiments does not require labelled training data. This may significantly reduce the over-the-air transmission overhead due to model adaptation.

Some embodiments may provide a method of consistent training-deployment feature discrepancy monitoring.

In some embodiments, by minimizing the distance between the pre-stored environment distribution and field environment distribution in the domain adaptation module, the representations from both environments are learned and the model may be applied in the field environment with the minimal loss in reconstruction accuracy.

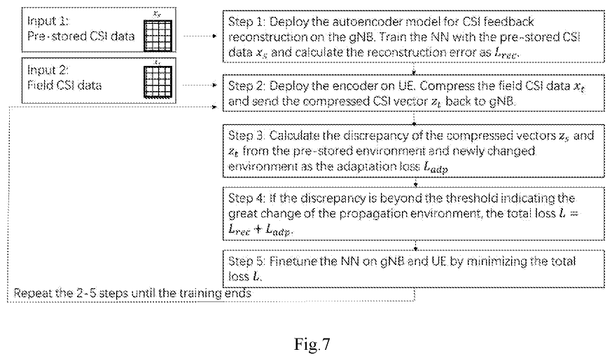

Reference is made to FIG. 7 which shows a method of some embodiments.

In step 1, the autoencoder model is deployed on gNB for CSI feedback reconstruction.

The model is trained with the pre-stored CSI data xₛ as the input.

The outputs of the model are the reconstructed CSI data [symbol] .

The reconstruction error between the reconstructed CSI data [symbol] and corresponding input CSI data xₛ is determined. The reconstruction error is denoted the reconstruction loss L_{rec}.

In step 2, the encoder is deployed on the UE with the field CSI data xₜ as the input. The output compressed CSI vector z_{_t} is sent to gNB.

In step 3, the compressed CSI vectors z_{_s} and z_{_t}, which are from the pre-stored CSI data and the field CSI data respectively, are fed into the domain adaptation module to determine the discrepancy between the pre-stored environment and drifted environment. This discrepancy is the adaptation loss L_{adp}.

In step 4, if the discrepancy is beyond a threshold indicating a relatively large change in the propagation environment, the total loss L=L_{rec}+L_{adp}. Otherwise, the loss L=L_{rec}. In another embodiment, the discrepancy can be determined based on one or more indicators such as previously discussed. If the indicator(s) satisfies a criteria, adaptation is initiated by adding L_{adp} to the loss term.

In step 5, the NNs on gNB and UE are finetuned by minimizing the total loss L.

Some example simulations are now described. The simulation datasets are generated for link-level eigenvector-based CSI feedback research according to 3GPP TR 38.901. The dataset configurations are given below.

| | CDLC30 | CDLC300 | CDLC30 | CDLC300 |
|---|---|---|---|---|
| | 48RB | 48RB | 52RB | 52RB |
| Carrier | 4 GHz | | 3.5 GHz | |
| Frequency | | | | |
| Bandwidth | 10 MHz | | | |
| Subcarrier | 15 KHz | | | |
| Spacing | | | | |
| RB Number | 52 | | 48 | |
| Sub-band | 13 | | 12 | |
| Number | | | | |
| Antenna | 32 Tx ports: | | 32 Tx ports: | |
| Configuration | (8, 8, 2, 1, | | (4, 4, 2, 1, | |
| | 1, 2, 8), | | 1, 1, 1), | |
| | (dH, dV) = | | (dH, dV) = | |
| | (0.5, 0.8)λ, | | (0.5, 0.5)λ, | |
| | directional | | directional | |
| | 4 Rx ports: | | 4 Rx ports: | |
| | (1, 2, 2, 1, | | (1, 2, 2, 1, | |
| | 1, 1, 2), | | 1, 1, 1), | |
| | (dH, dV) = | | (dH, dV) = | |
| | (0.5, 0.5)λ, omni- | | (0.5, 0.5)λ, | |
| | directional | | directional | |
| Channel | CDL-C | | | |
| Model | | | | |
| Delay | 30 ns | 300 ns | 30 ns | 300 ns |
| Spread | | | | |
| Sample Slot | 100 | | | |
| Interval | | | | |
| UE Speed | 3 km/h | | | |
| Rank | 1 | | | |
| Channel | ideal | | | |
| Estimation | | | | |

| | |
|---|---|
| UE Number | 1000 |
| Slot Number | 100 |

CDLC30 represents the CDLC channel model with 30 ns delay spread and CDLC300 represents CDLC channel model with 300 ns delay spread.

In the simulation, two cases are tested:
52 resource block (RB), CDLC30->CDLC300
48 RB, CDLC300->CDLC30

For each case, the model shown in FIG. 4 (that is without a domain adaptation module) was used as a baseline. In the baseline scheme, the model is trained with the pre-stored data and tested on both pre-stored data and field data. The sample numbers for model training and testing are presented in the table below.

| | Train | Test |
|---|---|---|
| Proposed scheme | 40k pre-stored | 8k pre-stored |
| (with domain | samples | samples |
| adaptation module) | (labelled) | 8k field |
| | | samples |
| Baseline scheme | 40k pre-stored | 8k pre-stored |
| (without domain | samples | samples |
| adaptation module) | (labelled) | 8k field |
| | 40k field | samples |
| | samples | |
| | (labelled) | |

In the simulation, each sample includes 832 real numbers, which corresponds to a large eigenvector concatenated by 13 sub-bands as:

$$w = [ {w}_{1} , {w}_{2} , … , {w}_{13} ]$$

where wₖ (1<k≤13) is the eigenvector for the k-th sub-band channel. Each wₖ has been processed as the following format:

$${w}_{k} = [ Re \{ {w}_{k , 1} \} , Im \{ {w}_{k , 1} \} , Re \{ {w}_{k , 2} \} , Im \{ {w}_{k , 2} \} , … , Re \{ {w}_{k , 32} \} , Im \{ {w}_{k , 32} \} ]$$

where Re{⋅} and Im{⋅} are the real and imaginary parts.

An example NN architecture is used for the proposed scheme. First, denote the encoder input size as N (N=832 in this simulation) and the compression ratio as γ (γ=1/64 in this simulation).

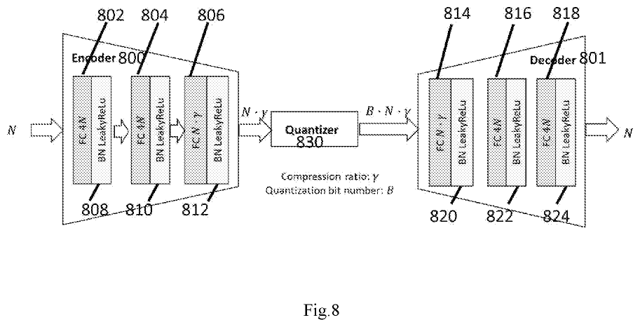

An example encoder and decoder is shown in FIG. 8. It should be appreciated that the encoder and decoder of embodiments may have fewer or more than the example layers shown in FIG. 8. Different embodiments may use one or more different layers in addition and/or in the alternative to one or more layers shown in FIG. 8. The number of neurons of each layer is by way of example.

The encoder 800 has three fully connected FC layers 802, 804 and 806. Each FC layer is followed by a batch normalization BN/activation layer 808, 810 and 812. In this example, the activation function in neural network implementation is a leaky ReLu (Rectified Linear unit) function.

The input N is received by the first FC layer 802 and the output N·γ of the encoder is provided by the third BN/activation layer 812. In this example, the first FC layer 802 has 4 N neurons, the second FC layer 804 has 4 N neurons, and the third FC layer 802 has N·γ neurons.

The decoder 801 has three fully connected FC layers 814, 816 and 818. Each FC layer is followed by a batch normalization BN/activation layer 820, 822 and 824. In this example, the activation function is a leaky ReLu.

The input is the output of the encoder—N·γ. This output is received by the first FC layer 814 and the output N of the decoder is provided by the third BN/activation layer 824. In this example, the first FC layer 814 has N·γ neurons, the second FC layer 816 has 4 N neurons, and the third FC layer 818 has 4 N neurons.

The encoder and decoder will mirror each other in terms of layers.

In some embodiments, since the CSI is fed back in the form of bitstream, a quantizer 830 may be used. This is shown in FIG. 8 where the output of the encoder is input to the quantizer and the output of the quantizer is input to the decoder. The quantizer may be realized by uniform-quantification or non-uniform quantization. In this example, uniform quantification is used and the quantization can be written as:

$${s}_{q} = \frac{round ( {2}^{B - 1} \times s )}{{2}^{B - 1}}$$

where s is the output of encoder, s_{q} is the output of quantizer, and B is the quantization bit number. In this example MMD is utilized as the domain adaptation module to minimize the discrepancy between the pre-stored data and the field data.

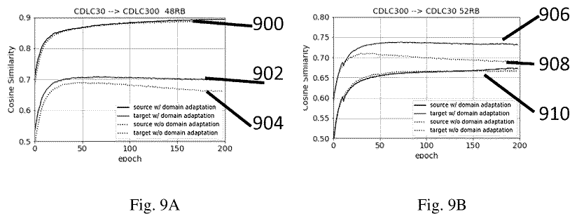

Reference is made to FIGS. 9a and 9b which show graphs of cosine similarity against time (epoch). FIG. 9a is of the 52 RB, CDLC30->CDLC300 case and FIG. 9b is for the 48 RB, CDLC300->CDLC30 case. In the following source refers to the pre-stored data and target refers to the field data. For FIG. 9a, the plot referenced 900 is the source with domain adaptation, the plot referenced 902 is the target with domain adaptation, and the plot referenced 904 is the source without domain adaptation (baseline). For FIG. 9b, the plot referenced 906 is the target with domain adaptation, the plot referenced 908 is the target without domain adaptation, and the plot referenced 910 is the source without domain adaptation.

In FIG. 9a, the source is CDLC30 and the target is CDLC300. The delay spread of CDLC30 equals 30 ns, making its CSI pattern “flatter/easier” than the CSI pattern of CDLC300. Therefore, the model often presents better CSI feedback accuracy in CDLC30 than in CDLC300, whether CDLC30 is the source domain or target domain.

As shown in FIGS. 9a and 9b, it can be observed that unsupervised learning approach of some embodiments may augment CSI feedback reconstruction accuracy in the field environment. As shown in FIG. 9a and FIG. 9b, respective lines 902 and 906 present higher CSI feedback than respective lines 904 and 908 (with domain adaption), This indicates that some embodiments may augment CSI feedback reconstruction accuracy in the field environment.

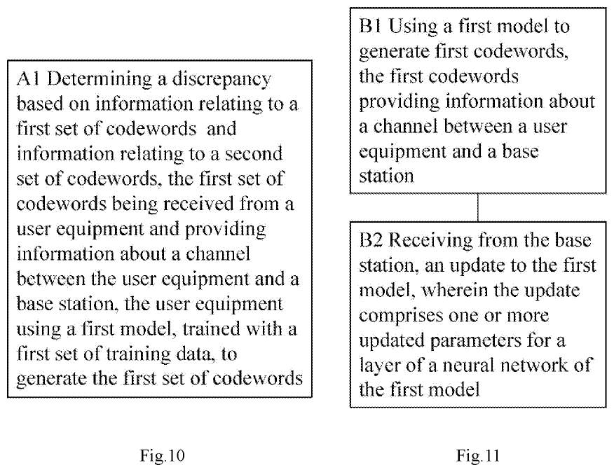

Reference is made to FIG. 10 which shows a method of some embodiments.

This method may be performed by an apparatus. The apparatus may be in or be a base station.

The apparatus may comprise suitable circuitry for providing the method.

Alternatively or additionally, the apparatus may comprise at least one processor and at least one memory storing instructions that, when executed by the at least one processor cause the apparatus at least to provide the method below.

Alternatively or additionally, the apparatus may be such as discussed in relation to FIG. 2.

The method may be provided by computer program code or computer executable instructions.

The method may comprise as referenced Al, determining a discrepancy based on information relating to a first set of codewords and information relating to a second set of codewords, the first set of codewords being received from a user equipment and providing information about a channel between the user equipment and a base station, the user equipment using a first model, trained with a first set of training data, to generate the first set of codewords

It should be appreciated that the method outlined in FIG. 10 may be modified to include any of the previously described features.

Reference is made to FIG. 11 which shows another method of some embodiments.

This method may be performed by an apparatus. The apparatus may be in or be a user equipment.

The apparatus may comprise suitable circuitry for providing the method.

Alternatively or additionally, the apparatus may comprise at least one processor and at least one memory storing instructions that, when executed by the at least one processor cause the apparatus at least to provide the method below.

Alternatively or additionally, the apparatus may be such as discussed in relation to FIG. 3.

The method may be provided by computer program code or computer executable instructions.

The method may comprise as referenced B1, using a first model to generate first codewords, the first codewords providing information about a channel between a user equipment and a base station.

The method may comprise as referenced B2, receiving from the base station, an update to the first model, wherein the update comprises one or more updated parameters for a layer of a neural network of the first model.

It should be appreciated that the method outlined in FIG. 11 may be modified to include any of the previously described features.

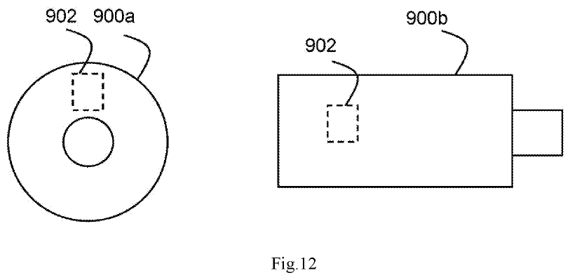

FIG. 12 shows a schematic representation of non-volatile memory media 900a or 900b storing instructions and/or parameters which when executed by a processor allow the processor to perform one or more of the steps of the methods of any of the embodiments. The non-volatile memory media may be a computer disc (CD), or digital versatile disc (DVD) schematically referenced 900a or a universal serial bus (USB) memory stick schematically referenced 900b. The computer instructions or code may be downloaded and stored in one or more memories. The memory media may store instructions and/or parameters 902 which when executed by a processor allow the processor to perform one or more of the steps of the methods of embodiments.

Computer program code may be downloaded and stored in one or more memories of the device.

It is noted that while the above describes example embodiments, there are several variations and modifications which may be made to the disclosed solution without departing from the scope of the present invention.

It is noted that whilst some embodiments have been described in relation to 5G networks, similar principles can be applied in relation to standards.

Therefore, although certain embodiments were described above by way of example with reference to certain example architectures for wireless networks, technologies and standards, embodiments may be applied to any other suitable forms of communication systems than those illustrated and described herein.

It is also noted herein that while the above describes example embodiments, there are several variations and modifications which may be made to the disclosed solution without departing from the scope of the present invention.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

In general, the various embodiments may be implemented in hardware or special purpose circuitry, software, logic or any combination thereof. Some aspects of the disclosure may be implemented in hardware, while other aspects may be implemented in firmware or software which may be executed by a controller, microprocessor or other computing device, although the disclosure is not limited thereto. While various aspects of the disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The embodiments of this disclosure may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The term “non-transitory,” as used herein, is a limitation of the medium itself (i.e., tangible, not a signal) as opposed to a limitation on data storage persistency (e.g., RAM vs. ROM).

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may comprise one or more of general-purpose computers, special purpose computers, microprocessors, digital signal processors (DSPs), application specific integrated circuits (ASIC), FPGA, gate level circuits and processors based on multi core processor architecture, as non-limiting examples.

Embodiments of the disclosure may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The scope of protection sought for various embodiments of the disclosure is set out by the claims. The embodiments and features, if any, described in this specification that do not fall under the scope of the claims are to be interpreted as examples useful for understanding various embodiments of the disclosure.

It should be noted that different claims with differing claim scope may be pursued in related applications such as divisional or continuation applications.

The foregoing description has provided by way of non-limiting examples a full and informative description of the exemplary embodiment of this disclosure. However, various modifications and adaptations may become apparent to those skilled in the relevant arts in view of the foregoing description, when read in conjunction with the accompanying drawings and the appended claims. However, all such and similar modifications of the teachings of this disclosure will still fall within the scope of this invention as defined in the appended claims. Indeed, there is a further embodiment comprising a combination of one or more embodiments with any of the other embodiments previously discussed.

1. A method comprising:
determining a discrepancy based on information relating to a first set of codewords and information relating to a second set of codewords, the first set of codewords being received from a user equipment and providing information about a channel between the user equipment and a base station, the user equipment using a first model, trained with a first set of training data, to generate the first set of codewords.

2. The method as claimed in claim 1, wherein the second set of codewords are obtained from a stored set of data.

3. The method as claimed in claim 2, wherein the stored set of data comprises the first set of training data.

4. The method as claimed in claim 1, comprising triggering the determining of the discrepancy in response to a system level indicator crossing a threshold and using the discrepancy to update the first model.

5. The method as claimed in claim 1, comprising based on the discrepancy, determining if the first model is to be updated.

6. The method as claimed in claim 5, wherein determining if the first model is to be updated comprises comparing the discrepancy to a threshold.

7. The method as claimed in claim 1, wherein the updating of the first model comprises updating a neural network of the first model.

8. The method as claimed in claim 7, comprising updating the first model by training the neural network of the first model using a back propagation algorithm to determine one or more updated parameters for a layer of the neural network of the first model.

9. The method as claimed in claim 8, comprising causing the one or more updated parameters to be sent to the user equipment to update the first model on the user equipment.

10. The method as claimed in claim 8, wherein the one or more updated parameters are gradients for the layer of the neural network of the first model.

11. The method as claimed in claim 1, wherein the codewords provide channel state information.

12. The method as claimed in claim 1, wherein the codewords provide channel information in a multiple input multiple output environment.

13. The method as claimed in claim 1, comprising training the first model to provide encoding in the user equipment using the first set of training data and causing the first model to be provided to the user equipment.

14. The method as claimed in claim 13, comprising training a second model to provide decoding in the base station, the training of the second model using the first set of training data.

15. The method as claimed in claim 14, comprising training the second model to provide decoding in the base station using an output of the first model.

16. The method as claimed in claim 13, comprising determining a reconstruction loss based on input to the first model and output from the second model and updating the first model in dependence on the discrepancy and the reconstruction loss.

17. The method as claimed in claim 1, comprising determining the discrepancy based on a measure of a distance between a distribution of the first codewords and a distribution of the second codewords.

18. An apparatus comprising:
at least one processor; and
at least one memory, storing instructions that, when executed by the at least one processor, cause the apparatus at least to perform the method according to claim 1.

19-24. (canceled)
